(19) United States
(12) Patent Application Publication
(10) Pub. No.: US 2007/0116594 A1
(43) Pub. Date: May 24, 2007

(54) Analytical microchip

(75) Inventors: Yuichiro Shimizu, Soraku-gun (JP); Kazuo Hashiguchi, Ikoma-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/600,911

(22) Filed: Nov. 17, 2006

(30) Foreign Application Priority Data
Nov. 18, 2005 (JP) 2005-334042
Sep. 14, 2006 (JP) 2006-249767

(51) Int. Cl. G01N 31/22

(52) U.S. Cl. 422/57

(57) ABSTRACT

The detection accuracy and detection reproducibility of an analytical microchip utilizing beads are improved. To this end the analytical microchip has a reaction path 17 having a particle-filled area 19 filled with a group of solid particles, a test-solution introducing path 11 for introducing a test solution into the reaction path, a test-solution discharging path 14 for discharging a test solution inside the reaction path to outside of the microchip, and a particle injection aperture 16 provided on one end side of the reaction path 17. The test-solution discharging path 14 has a direct communication with the particle-filled area 19 in the reaction path 17. The test-solution introducing path 11 has a direct communication with the reaction path 17 on the upper stream side relative to the test-solution discharging path 14 and within the upper-stream-side end surface 22 of the particle-filled area 19. A first damming portion 12 is provided at the point of connection of the test-solution introducing path 11 and the reaction path 17. A second damming portion 13 is provided at the point of connection of the test-solution discharging path 14 and the reaction path 17.

### BACKGROUND OF THE INVENTION

1) Field of the Invention

The present invention relates to analytical microchips used for micro-chemical analysis and microreactors.

2) Description of the Related Art

In recent years, micromachining technology (Micro Electro-Mechanical System, MEMS), which utilizes microprocessing technology of semiconductors, is drawing attention. In the field of analytical chemistry, micromachining technology (Micro Total Analytical System, μ-TAS) is rapidly developing for protein and genes in biochemistry. In the latter technology, which uses antigen-antibody reactions, a reactant (e.g., an antibody) is immobilized directly on a reaction portion, and a solution containing an antigen is allowed to flow in this portion, thereby obtaining a antigen-antibody reaction. However, with this conventional method, the reaction surface area cannot be sufficiently enlarged, making it impossible to reliably bring the solution containing the antigen into contact with the reaction surface. This causes variation in reaction, and thus sufficient detection accuracy cannot be obtained.

In view of this, Patent Document 1 suggests a technique to form a porous structure in the reaction path and immobilize antigens, antibodies, and the like therein, in order to enlarge the reaction surface area.

According to this technique, although the reaction surface area can be enlarged, the device structure becomes complicated since the porous structure is formed by photopolymerization. In addition, this technique involves direct immobilization of antigens, antibodies, and the like in the porous structure, and thus reactants cannot be easily replaced, making repeated use of the porous structure difficult.

Patent Document 1: Japanese Patent Application Publication No. 2004-317128.

Non-patent document 1 and patent document 2 suggest a technique to immobilize reactants on the surfaces of solid particles such as glass beads to serve as a reactive solid phase. This technique provides the following advantages (1)-(3).

(1) The reaction surface area can be enlarged, and the device can be repeatedly used by the simple operation of removing beads after reaction and injecting unreacting beads.

(2) Since the reactants can be immobilized on the beads outside the chip, the immobilization of the reactants are easier than the case of the porous structure.

(3) Since the reaction surface area can be enlarged by densely injecting solid particles, a highly sensitive and short-time analysis is made possible.

Non-patent document 1: Kiichi Sato, Manabu Tokeshi et al., Anal. Chem. Vol. 72, pages 1144-1145.

Patent document 2: Japanese Patent Application Publication No. 2001-4628.

Although non-patent document 1 and patent document 2 provide the above advantages, use of beads as a reactive phase requires prevention of the beads from flowing out of the reactive phase. The above documents suggest, as a method to prevent flow of beads, a bead damming structure. For example, in non-patent document 1, as shown in FIG. 7(a), a bead damming portion 113 is provided, and a flow path 111 formed between the bead damming portion 113 and a lid member 101 is made narrower than the diameter of the beads. This causes a group of beads 112 to be held in the flow path 111. As a method to inject beads, a tube is connected to a portion on the upper stream side of the bead damming portion 113, and a bead suspension is injected into the chip through the tube.

However, in the bead suspension, a concentration gradient easily occurs due to sedimentation or floatation of the beads. In addition, the beads are lost through the injection of the bead suspension by adhering to the pump and the inner tube. It is thus difficult to inject and locate an accurate amount of beads in a predetermined portion of the flow path by the technique of injecting the bead suspension into the chip. Further, there is no easy and accurate method to measure the amount of the beads filled in the flow path. Thus, the amount of filled beads varies on a chip-by-chip basis, causing variation of detection accuracy.

Further, with extremely fine beads, when a solution passes through an area filled with fine beads, the flow resistance becomes excessively large, and thus the flow rate and the amount of solution supply per unit time easily fluctuate. This causes degradation of detection reproducibility. Further, when extremely fine beads are filled in the chip, the large flow resistance makes it difficult to sufficiently wash inside of the flow path, and thus unreacting reactants are left in the flow path. This causes degradation of quantitative accuracy. Thus, the technique of non-patent document 1 is problematic in reliability in detection accuracy.

Patent document 2 suggests a microchip provided with a microchannel reaction chamber having a cross-sectional area larger than the diameters of solid particles and a microchannel separator having a longitudinal cross-sectional area smaller than the diameters of the solid particles. According to this technique, the microchannel separator, which has a longitudinal cross-sectional area smaller than the diameters of the solid particles, prevents the solid particles from flowing out of the microchannel reaction chamber, which is filled with the solid particles. It is claimed that this provides an easy method for reaction and separation detection with a shortened time and high accuracy.

However, even with the technique of patent document 2, the amount of filled solid particles cannot be controlled accurately, and thus it is impossible to sufficiently prevent variation in detection accuracy resulting from variation in the amount of filled solid particles.

### SUMMARY OF THE INVENTION

As described above, while analytical microchips using solid particles such as beads are advantageous because they have simple structures, are easy to handle, and provide highly sensitive detection in a short time, it is difficult to inject an accurate amount of solid particles into the chip. This poses the problem of insufficient detection reproducibility. It is therefore an object of the present invention to solve the problem.

It is another object of the present invention to provide an analytical microchip that uses solid particles having reactants immobilized thereon, that has a simple structure and is easy to handle, and that is excellent in detection reproducibility.

In order to accomplish the above and other objects, an analytical microchip according to a group of inventions is configured as follows.

[First Invention Group]

(1) An analytical microchip according to a first invention group is configured as follows.

An analytical microchip comprising: a reaction path formed in the microchip, the reaction path having a particle-filled area filled with a group of solid particles having reactants immobilized on surfaces of the solid particles; a test-solution introducing path for introducing a test solution into the reaction path from outside of the microchip; a test-solution discharging path for discharging a test solution inside the reaction path to outside the microchip; and a particle injection aperture for injecting solid particles into the reaction path, the particle injection aperture being provided on one end side of the reaction path, wherein: the test-solution discharging path has a direct communication with the particle-filled area in the reaction path; and the test-solution introducing path has a direct communication with the reaction path on an upper stream side relative to the test-solution discharging path and within the upper-stream-side end surface of the particle-filled area (first aspect).

The above analytical microchip may be at least composed of a main substrate having a groove for the reaction path, a groove for the test-solution introducing path, and a groove for the test-solution discharging path; and a lid substrate having a thorough aperture for the particle injection aperture, the lid substrate being superposed over the main substrate. The test-solution introducing path and the test-solution discharging path may extend in opposite directions from the reaction path (second aspect).

In the above analytical microchip according to the present invention, at the point of connection of the test-solution introducing path and the reaction path, a first damming portion for preventing solid particles from entering the test-solution introducing path may be provided. At the point of connection of the test-solution discharging path and the reaction path, a second damming portion for preventing solid particles from entering the test-solution discharging path may be provided (third aspect).

As shown in FIG. 1, a reaction path 17 has a particle-filled area 19 filled with solid particles. The particle-filled area 19 has an area in the reaction path into which a test solution is introduced from a test-solution introducing path 11. This area is the only area in the particle-filled area 19 to involve in reaction of the test solution. In this specification, this area will be perceived as a quantitative reaction zone.

While the quantitative reaction zone will be defined later, a quantitative reaction zone 20 is a zone so provided in the particle-filled area 19 of the reaction path 17 that the quantitative reaction zone 20 may have a predetermined, sufficient capacity.

In the above structure, the test-solution introducing path 11 has a direct communication with the reaction path 17 on the upper stream side relative to the test-solution discharging path 14 and within the upper-stream-side end surface of the particle-filled area 19, thereby forming the quantitative reaction zone 20. Even when the amount of solid particles to be injected in the reaction path fluctuates, there are no adverse effects of the fluctuation and the amount of solid particles (reactant amount) that actually involve in reaction is maintained at a constant level. That is, even when the reactant amount fluctuates in the entire chip, the reactant amount in the internal reaction-path area (quantitative reaction zone), in which the test solution flows, is constant. This solves such a problem that detection accuracy greatly fluctuates on a chip-by-chip basis. This also stabilizes detection accuracy in repeated use of the chip such that used solid particles in the chip are discharged out of the chip and new solid particles are injected.

These advantageous effects are more reliably secured in the third aspect, where the first damming portion and the second damming portion are provided. This is because the first damming portion and the second damming portion reliably prevent migration and fluctuation of solid particles. If the first damming portion and the second damming portion are not provided in the chip, a means of preventing runoff of solid particles is preferably provided outside the chip.

According to the second aspect, where the test-solution introducing path and the test-solution discharging path extend in opposite directions from the reaction path, the flow of the test solution is not localized either on the side of the test-solution introducing path or the side of the test-solution discharging path. This enhances detection accuracy. Further, this structure is easily produced by superposing two substrates, the main substrate and back substrate.

As a reactant used in the analytical microchip according to the present invention, one of guest/hose molecules is used as a chemical material, and as a biological material, one of substances with binding specificity such as antigen-antibody-reaction materials is used. While as an antigen-antibody-reaction material a protein such as antigen-antibody, a protein such as a fragment of the foregoing protein, or the like can be used, other materials than a protein can be made a target such as a fine chemical material including environmental hormones.

The terms “an upper stream side” and “a lower stream side”, used above, are concepts based on the flow of the test solution introduced into the reaction path from outside of the chip for reaction in the chip, and are used in the same manner throughout the specification.

The above analytical microchip according to the present invention may further have: a washing aperture for injecting a washing solution to wash a group of solid particles in the reaction path out of the chip through the particle injection aperture, the washing aperture being provided at the lower stream end of the reaction path; and a third damming portion for damming solid particles, the third damming portion being provided on the upper stream side relative to the washing aperture and on the side of the washing aperture relative to the test-solution discharging path (fourth aspect).

In this aspect, a damming portion is provided on the lowermost stream side of the reaction path, and thus the desired particle-filled area can be formed using a smaller amount of solid particles. Also, the damming portion prevents the filled structure from crumbling through the flow of the test solution, thereby further enhancing detection stability. If the third damming portion is not provided in the chip, a means of preventing runoff of solid particles is preferably provided outside the chip. One example of such a means is placing a net over the washing aperture.

The above analytical microchip according to the present invention may be at least composed of a main substrate having a groove for the reaction path, a groove for the test-solution introducing path, and a groove for the test-solution discharging path; and a lid substrate having a thorough aperture for the particle injection aperture, the lid substrate being superposed over the main substrate. The test-solution introducing path and the test-solution discharging path may extend in opposite directions from the reaction path (fifth aspect).

If the test-solution introducing path and the test-solution discharging path are provided in the same direction from the reaction path, the flow of the test solution may be localized on the side where the test-solution introducing path and the test-solution discharging path are provided. The inventive structure, on the other hand, enables it to enhance detection accuracy and detection reproducibility with a simple structure, and further, this structure is easy to produce.

In the analytical microchip according to the fifth aspect, the washing aperture may be formed of a thorough aperture provided in the lid substrate, and the particle injection aperture may also serve as a solid-particle discharging aperture for discharging a group of solid particles out of the chip (sixth aspect).

The structure in which the particle injection aperture also serves as a solid-particle discharging aperture (also referred to as a first washing aperture) further simplifies the chip structure and is convenient for injection and washing of solid particles.

In the analytical microchip according to the fifth aspect, the lid substrate may further have: a thorough aperture for injecting a test solution into the test-solution introducing path from outside of the chip, the thorough aperture being formed on an uppermost stream side of the test-solution introducing path; and a thorough aperture for discharging a test solution out of the test-solution discharging path to outside of the chip, the thorough aperture being formed on the lowermost stream side of the test-solution discharging path (seventh aspect).

While the apertures for sending the test solution into and out of the chip can be formed on the side surfaces of the chip or on the main substrate, providing the apertures in the lid substrate facilitates communication with the outside of the chip. Thus, the seventh aspect further enhances the easiness of handling the analytical microchip.

[Second Invention Group]

(2) An analytical microchip according to a second invention group is configured as follows.

An analytical microchip comprising: a reaction path formed in the microchip, the reaction path having a particle-filled area filled with a group of solid particles having reactants immobilized on the surfaces of the solid particles; a test-solution introducing path for introducing a test solution into the reaction path from outside of the microchip; a test-solution discharging path for discharging a test solution inside the reaction path to outside of the microchip; and a particle injection aperture for injecting solid particles into the reaction path, the particle injection aperture being provided on one end side of the reaction path, wherein: the test-solution introducing path is composed of a plurality of introducing paths; the test-solution discharging path is composed of at least one discharging path; the plurality of introducing paths each have a direct communication with the reaction path within the end surfaces defining the particle-filled area, the lowermost-stream-side inner surfaces of a lowermost-stream-side flow path of the plurality of introducing paths being located at an equal level or on an upper stream side relative to the lowermost-stream-side wall surface of a lowermost-stream-side discharging path of the at least one test-solution discharging path (eighth aspect).

In this structure, the test-solution introducing path is composed of a plurality of introducing paths, and thus there are increased points where an unreacting test solution comes into contact with the group of solid particles. This enables it to reduce the injection pressure at the time of injecting the test solution. Thus, it becomes easier to uniformize the reaction between the test solution and the reactants on the solid particles, thereby enhancing detection reproducibility. In the analytical microchip having this structure, the quantitative reaction zone is the particle-filled area defined by an imaginary plane including the lowermost-stream-side inner surface of the lowermost-stream-side flow path of the plurality of introducing paths and an imaginary plane including the lowermost-stream-side wall surface of the lowermost-stream-side discharging path of the at least one test-solution discharging path.

In the analytical microchip according to the present invention, the plurality of introducing paths may have a multi-stepwise furcation structure having, on the uppermost stream side, a single flow path furcating into branches in a multi-stepwise manner toward the lower stream side (ninth aspect).

In this structure, as shown at a test-solution introducing path 51 in FIG. 4, a single flow path at the entrance furcates into branches in a multi-stepwise manner in the flow direction. This necessitates only one pump for injecting the test solution, and enables it to inject an unreacting test solution into the particle-filled area from a plurality of points with equal pressure and at an equal injection rate. As a result, quantitation accuracy is enhanced.

In the analytical microchip according to the present invention, the test-solution discharging path may have an inverse multi-stepwise furcation structure furcating into branches in a multi-stepwise manner from the lowermost stream side of the discharging path toward the upper stream side thereof down to the point of connection with the reaction path (tenth aspect).

In an analytical microchip of this structure, as shown at a test-solution discharging path 85 in FIG. 5, a discharged solution discharged out of the reaction path can be collected into a single discharge aperture 86. This is particularly useful in quantitating, outside the reaction path, a product generated inside the reaction path. With a test-solution discharging path having the inverse multi-stepwise furcation structure (see FIG. 5), even if there is a difference of concentration among the discharged-solution components discharged into each of the branch discharging paths, the components are automatically mixed in the course of collection of the discharged solution into one discharge aperture. By quantitating the discharged solution on the lower stream side, where there is a single discharging aperture, a product generated inside the reaction path can be advantageously quantitated in an averaged state.

In the analytical microchip according to the present invention, the test-solution discharging path may have a wide connection portion with the reaction path in a longitudinal direction of the reaction path, the wide connection portion tapering toward the lower stream side of the test-solution discharging path, whereby the test-solution discharging path is a single discharging path having a tapering shape. The lower-stream-side inner wall of the test-solution discharging path at the connection portion with the reaction path may be located at an equal level or on a lower stream side relative to a lower-stream-side inner surface of a lowermost stream-side flow path of the plurality of introducing paths (eleventh aspect).

With this structure, as shown at a test-solution discharging path 52 in FIG. 4, a single discharging path 52 having a tapering shape is used such that a wide width extending in the longitudinal direction of a reaction path 60 tapers toward the lower stream side of the discharging path. This shape significantly enlarges the discharge area, thereby providing a smooth discharge of the test solution.

The analytical microchip according to the present invention may be at least composed of a main substrate having a groove for the reaction path, a groove for the test-solution introducing path, and a groove for the test-solution discharging path; and a lid substrate having a thorough aperture for the particle injection aperture, the lid substrate being superposed over the main substrate. The test-solution introducing path and the test-solution discharging path may extend in opposite directions from the reaction path (twelfth aspect).

If the test-solution introducing path and the test-solution discharging path are provided in the same direction from the reaction path, the flow of the test solution may be localized on the side where the test-solution introducing path and the test-solution discharging path are provided. The inventive structure, on the other hand, enables it to enhance detection accuracy and detection reproducibility with a simple structure, and further, this structure is easy to produce.

In the analytical microchip according to the twelfth aspect, the washing aperture may be formed of a thorough aperture provided in the lid substrate, and the particle injection aperture may also serve as a solid-particle discharging aperture for discharging a group of solid particles out of the chip (thirteenth aspect).

The structure in which the particle injection aperture also serves as a solid-particle discharging aperture (also referred to as a first washing aperture) further simplifies the chip structure and is convenient for injection and washing of solid particles.

In the analytical microchip according to the twelfth aspect or the thirteenth aspect, a thorough aperture for injecting a test solution into the test-solution introducing path from outside of the chip may be formed on the uppermost stream side of the test-solution introducing path. A thorough aperture for discharging a test solution out of the test-solution discharging path to outside the chip may be formed on the lowermost stream side of the test-solution discharging path (fourteenth aspect).

While the apertures for sending the test solution into and out of the chip can be formed on the side surfaces of the chip or on the side of the main substrate, providing the apertures in the lid substrate facilitates communication with the outside of the chip. Thus, the fourteenth aspect further enhances the easiness of handling the analytical microchip.

In the-analytical microchip according to the present invention, a first damming portion for preventing solid particles from entering the test-solution introducing path may be provided at the point of connection of the test-solution introducing path and the reaction path, and a second damming portion for preventing solid particles from entering the test-solution discharging path may be provided at the point of connection of the test-solution discharging path and the reaction path (fifteenth aspect).

With this structure, where a first damming portion and a second damming portion are provided, runoff of solid particles is prevented, thereby further enhancing detection reproducibility. If the first damming portion and the second damming portion are not provided in the chip, a means of preventing runoff of solid particles is preferably provided outside the chip.

The analytical microchip according to the present invention may further has: a washing aperture for injecting a washing solution to wash a group of solid particles in the reaction path out of the chip through the particle injection aperture, the washing aperture being provided at the lower stream end of the reaction path; and a third damming portion for damming solid particles, the third damming portion being provided on the upper stream side relative to the washing aperture and on the side of the washing aperture relative to the test-solution discharging path (sixteenth aspect).

In this aspect, a damming portion is provided on the lowermost stream side, and thus the desired particle-filled area can be formed using a smaller amount of solid particles. Also, the damming portion prevents the filled structure from crumbling through the flow of the test solution, thereby enhancing detection stability. If the third damming portion is not provided in the chip, a means of preventing runoff of solid particles is preferably provided outside the chip. One example of such a means is placing a net over the washing aperture.

(3) According to each of the inventions, the amount of solid particles involved in reaction can be specified and maintained at a constant level in a self-aligning manner by using a simple inner-chip flow path structure, and thus an analytical microchip excellent in easiness of handling and detection reproducibility is realized.

### BRIEF DESCRIPTION OF THE DRAWINGS

FIG. 1 is a plan view of a microchip according to embodiment 1 of the present invention.

FIG. 2 is a sectional view of the microchip shown in FIG. 1 taken along the line A-A.

FIG. 3 is a partially enlarged view and a schematic plan view of the microchip shown in FIG. 2, describing a particle-filled area and a quantitative reaction zone.

FIG. 4 is a plan view of a microchip according to embodiment 2 of the present invention, where a test-solution introducing path having a multi-stepwise furcation structure and a test-solution discharging path composed of a tapering discharging path are combined.

FIG. 5 is a plan view of a microchip combining a test-solution introducing path having a multi-stepwise furcation structure and a test-solution discharging path having an inverse multi-stepwise furcation structure.

FIG. 6 is a conceptual view of an analytical apparatus using the microchip according to embodiment 1.

FIG. 7(a) is a sectional view of a microchip according to comparative example 1. FIG. 7(b) is a conceptual view of an analytical apparatus using the chip.

### Reference Numeral

1 Analytical microchip
2 Main substrate
3 Lid substrate
10, 55, 81 Test-solution introducing aperture
11, 51, 82 Test-solution introducing path
12, 57, 83 First damming portion
13, 58, 84 Second damming portion
14, 52, 85 Test-solution discharging path
15, 56, 86 Test-solution discharging aperture
16, 53, 87 Particle injection aperture (also serving as first washing aperture)
17, 60, 88 Reaction path
18, 54, 92 Second washing aperture
19, 61, 89 Particle-filled area
20, 62, 90 Quantitative reaction zone
21, 59, 91 Third damming portion
22, 63, 93 Upper-stream-side end surface of the particle-filled area

### DESCRIPTION OF THE PREFERRED EMBODIMENTS

Preferred embodiments of the present invention will be described with reference to the drawings.

### Embodiment 1

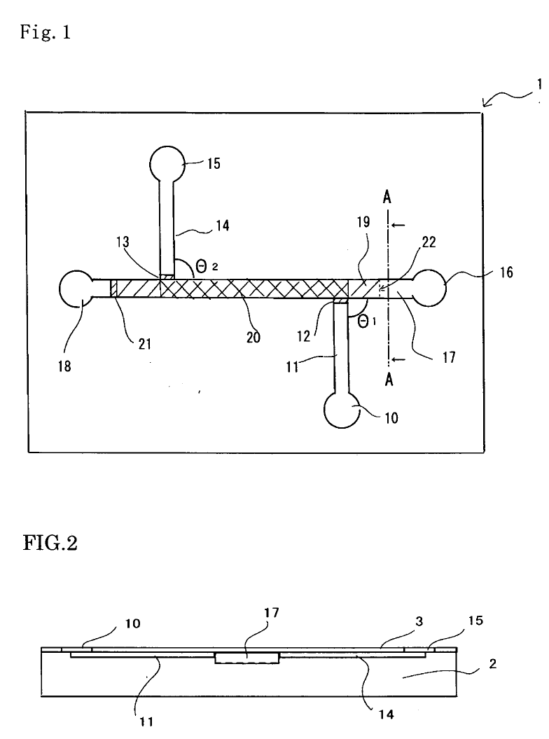

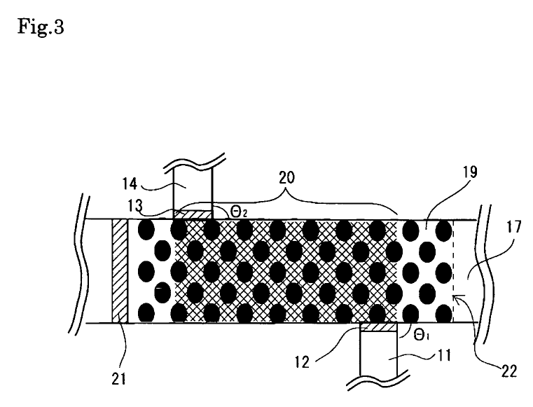

An analytical microchip 1 according to embodiment 1 will be described with reference to FIGS. 1 to 3. FIG. 1 is a plan view of the analytical microchip 1, FIG. 2 is a sectional view of the analytical microchip 1 taken along the line A-A, and FIG. 3 is a partially enlarged view mainly of a solid-particle-filled area of the analytical microchip 1.

<Main Portions of the Chip>

First, the main portions (the essential constituent elements of the present invention) of the analytical microchip 1 will be described referring to FIG. 3. The analytical microchip 1 according to the present invention has: a reaction path 17 composed of a depression groove formed on a main substrate 2; a particle-filled area 19 formed by filling the reaction path 17 with a group of solid particles having reactants immobilized on the surfaces of the solid particles; a test-solution introducing path 11 for introducing a test solution into the reaction path 17 from outside of the microchip; a test-solution discharging path 14 for discharging a test solution flowing inside the reaction path to outside of the microchip; and a particle injection aperture (not shown) for injecting solid particles into the reaction path 17. The particle injection aperture is provided on one end side, either on the upper stream side or lower stream side, of the reaction path 17.

The test-solution introducing path 11 has a direct communication with the particle-filled area 19 on an upper stream side of the reaction path 17 relative to the test-solution discharging path 14 and within an upper-stream-side end surface 22 of the particle-filled area 19 so that a test solution flows directly into the particle-filled area 19. The test-solution discharging path 14 has a direct communication with the particle-filled area 19 on a lower stream side thereof so that a test solution flowing inside the particle-filled area 19 is discharged out of the reaction path 17. Further, a first damming portion 12 for preventing the test solution from entering the test-solution introducing path 11 is provided at the point of connection of the test-solution introducing path 11 and the reaction path 17, and a second damming portion 13 for preventing the test solution from entering the test-solution discharging path 14 is provided at the point of connection of the test-solution discharging path 14 and the reaction path 17.

While the first and second damming portions 12 and 13 shown in FIG. 1 are provided at the side of the test-solution introducing path 11 and the side of the test-solution discharging path 14, respectively, the first and second damming portions 12 and 13 can be provided each at the side of the reaction path 17. In order to fill the reaction path uniformly with solid particles, however, the damming portions are preferably provided at the side of the test-solution introducing path and the side of the test-solution discharging path.

<Particle-Filled Area and Reaction Zone>

In the above-described structure, the particle-filled area 19 (the portion hatched in one direction in FIG. 1), which is filled with solid particles, is formed beyond the test-solution introducing path 11 and the test-solution discharging path 14. This structure provides such an advantageous effect that the amount of solid particles in the area (hereinafter referred to as a quantitative reaction zone 20) defined by the test-solution introducing path 11 and the test-solution discharging path 14 can be specified reliably and easily without special care. This will be described in detail. The test-solution introducing path 11 and the test-solution discharging path 14 will be hereinafter simply referred to as the introducing path 11 and the discharging path 14, respectively.

For example, if the upper stream side of the reaction path were extended in order to inject a test solution from somewhere in the extended portion, and if the lower stream side of the reaction path were extended to make somewhere in the extended portion a discharging path, then all particles in the reaction path would involve in reaction, which necessitates accurately specifying the amount of particles to be injected into the reaction path, in order to enhance analysis accuracy. Even if the amount of solid particles were measured accurately, some of the solid particles could be lost by attaching to a path (e.g., inside a tube for particle injection) to the reaction path. Thus, it is difficult to accurately fill the reaction path with a constant amount of particles. Also, it is difficult to accurately know the amount of particles after filling the reaction path.

Contrarily, in the chip of the inventive structure, the quantitative reaction zone 20 (the cross hatched portion in FIG. 1) is formed in the particle-filled area 19 (the portion hatched in one direction in FIG. 1). The quantitative reaction zone 20 is determined depending on the positions where the introducing path 11 and the discharging path 14 are located, and thus is not affected by the fluctuation of the amount of injected solid particles. That is, injecting a slightly excessive amount of particles into the reaction path 17 automatically results in a constant amount of particles injected into the quantitative reaction zone 20. In addition, in view of well reproducible analysis requiring that the order of alignment of a group of solid particles should not be changed by the fluctuation of rate of solution flow, the chip of the inventive structure has the particle-filled area 19, which is filled with solid particles, and the quantitative reaction zone 20, which is formed in the particle-filled area 19 and has a predetermined capacity. This is because if the order of alignment of a group of solid particles is changed, so is the flow of the test solution, thereby causing variation of detection accuracy.

The solid particles constituting the particle-filled area are injected from a particle injection aperture (not shown) provided on one end side, either on the upper stream side or lower stream side, of the reaction path 17. It should be noted that while in FIG. 3 the particles are distanced from one another for drawing purposes, filling particles are actually in contact with one another.

The quantitative reaction zone will be described in greater detail. When the reaction path 17, the introducing path 11, and the discharging path 14 are each in the form of a straight depression groove, and the reaction path 17 is orthogonal to the introducing path 11 and the discharging path 14, then the quantitative reaction zone 20 is a zone of the reaction path 17 defined by an imaginary line including the upper-stream-side wall surface of the introducing path 11 and an imaginary line including the lower-stream-side wall surface of the discharging path 14. The reaction path 17 may not necessarily be straight but may be, for example, in a meandering form. Also, the reaction path 17 may not necessarily be orthogonal to the introducing path 11 and the discharging path 14. Further, the introducing path 11 and the discharging path 14 may not necessarily have square cross sections but may have, for example, circular or U-shaped cross sections.

Since the diameters of the reaction path 17, the introducing path 11, and the discharging path 14 are minutely small (described later), there is only a slight amount of permeation. Thus, there are only small adverse effects of the permeation and a steady state can be easily reinstated. Therefore, by controlling the amount of the group of solid particles filling the zone, well reproducible qualitative analysis and quantitative analysis are made possible. It should be noted that in FIG. 3 the paths and the solid particles are made larger than they actually are for drawing purposes.

<Particle Injection Aperture and Others>

Next, embodiment 1 will be described in further detail referring also to other elements than the main constituent elements. As shown in FIG. 1, a particle injection aperture 16 for injecting solid particles into the reaction path 17 is provided on the uppermost stream side of the reaction path 17. The particle injection aperture 16 functions, in other events than injection of solid particles, as an aperture (first washing aperture) for injecting a washing solution for washing inside of the reaction path 17. The particle injection aperture 16 also functions as a discharging aperture (particle discharging aperture) for washing a group of used solid particles in the reaction path out of the chip.

A second washing aperture 18, forming a pair with the first washing aperture, is provided on the lowermost stream side of the reaction path 17. In ordinary washing, one of the first washing aperture 16 (particle injection aperture) and the second washing aperture 18 injects a washing solution into the other, from which the washing solution is discharged to outside of the chip. When a structure without a third damming portion, described later, is employed, solid particles may be injected or discharged from the second washing aperture. Therefore, the positions of the first washing aperture 16 and the second washing aperture 18 may be reversed.

In embodiment 1, however, a third damming portion 21, described later, is provided in front of the second washing aperture 18. In this case, solid particles cannot be injected into or discharged from other apertures than the first washing aperture 16, and thus solid particles are injected or discharged from the first washing aperture 16. Thus, a solid-particle suspension is injected from the first washing aperture 16 in order to form the particle-filled area 19 in the reaction path 17. When a group of used solid particles in the reaction path are washed out, a washing solution is injected from the second washing aperture 18 in order to cause a reverse flow relative to the flow caused by injection of solid particles, thereby washing the group of used solid particles out of the chip through the particle injection aperture (first washing aperture) 16.

As shown in FIGS. 1 and 2, a test-solution introducing aperture 10 for introducing a test solution into the chip is provided on the uppermost stream side of the test-solution introducing path 11. A test-solution discharging aperture 15 for discharging a processed test solution out of the chip is provided on the lowermost stream side of the test-solution discharging path 14. The introducing aperture 10, the discharging aperture 15, the particle injection aperture (first washing aperture) 16, and the second washing aperture 18 are formed of thorough apertures formed in the lid substrate 3. The lid substrate 3 in which the foregoing are formed and the main substrate 2 are adhered to each other using, for example, an adhesive so as to avoid solution leakage.

If the second washing aperture 18 is closed, there is no runoff of the solid particles, thereby eliminating the need for the third damming portion 21. Nevertheless, the third damming portion 21 is preferably provided. When only the test solution is washed out, a washing solution, instead of a test solution, may be allowed to flow through the test-solution introducing path 11. Use of the first and second washing apertures, however, enables it to flow a larger amount of washing solution with a smaller solution pressure, thus providing better washing efficiency.

<Damming Portions>

A first damming portion for preventing solid particles from entering the test-solution introducing path 11 is provided at the point of connection of the test-solution introducing path 11 and the reaction path 17. A second damming portion for preventing solid particles from entering the test-solution discharging path 14 is provided at the point of connection of the test-solution discharging path 14 and the reaction path 17. Further, as described above, a third damming portion is provided for damming solid particles is provided on the lower scream side relative to the test-solution discharging path 14 and on the upper stream side relative to the second washing aperture 18.

These damming portions are usually provided in the main substrate 2 and may have any structure insofar as it prevents migration of solid particles. Examples include a barrier structure in which the diameter (height or width) of the paths is smaller than the diameter of the solid particles, a structure composed of a plurality of small columns having gaps therebetween smaller than the diameter of the solid particles, and a network structure having apertures equal to or smaller than the diameter of the solid particles. When the solid particles are magnetic, a means of effecting magnetic force to the positions of damming the solid particles may be provided. In this case, the method of locating a magnetic-force generating means outside the chip and effecting a magnetic line of force to the damming positions may be employed, or a magnetic substance may be provided inside the paths (positions of damming the solid particles). When a flow path having a diameter smaller than the diameter of the solid particles is connected to a flow path having a larger diameter, the point of connection functions as a damming portion. The phraseology “a flow path having a diameter smaller than the diameter of the solid particles”, as used herein, means that either one of the inner diameter, height, and width of the flow path is small enough to be able to dam the solid particles.

<Substrate Materials and Others>

Materials for the main substrate 1 and the lid substrate 2 preferably do not allow permeation of the test solution, are not reactive to the test solution, and are easy to process. For example, when chemiluminescence is used as a detection means, transparent plastic materials with small autofluorescence are preferably used such as polyimide, polybenzimidazole, polyether ether ketone, polysulfone, polyether imide, polyether sulfone, and polyphenylene sulfide. When a means of electrochemical detection involving formation of an electrode in the chip is used, a material for either the substrate 1 or the substrate 2 is preferably glass, silicon, or the like.

The thickness of the main substrate 1 is usually 0.1-10 mm, and the thickness of the lid substrate 3 is 0.01-10 mm. The reaction path 17, the introducing path 11, and the discharging path 14 are grooves having a depth of 10 nm-200 μm, preferably 100 nm-100 μm, and a width of 10 nm-2000 μm, preferably 100 nm-100 μm. Usually, the diameter of the reaction path 17 is set to be larger than the diameters of the introducing path 11 and the discharging path 14, and preferably, the cross sectional area of the reaction path 17 is 2-100 times the cross sectional areas of the introducing path 11 and the discharging path 14.

The reaction path 17, the introducing path 11, and the discharging path 14 are formed of grooves formed in a substrate, and the particle injection aperture 16, which also serves as the first washing aperture, the second washing aperture 18, the test-solution introducing aperture 10, and the test-solution discharging aperture 15 are formed of thorough apertures formed in another substrate. Usually, the grooves are formed in the substrate 2, and the thorough apertures each have a circular cross section of 0.1-100 μm in diameter and are formed in the lid substrate 3. The cross section, however, is not limited to the circular shape.

<Processing Method of the Substrates>

When a plastic material is used for the substrates 2 and 3, the grooves and the apertures may be formed by, for example, the machining method, the laser processing method, the injection molding method using a metal mold, and the press molding method. Among these, the injection molding method using a metal mold is preferable for its excellent mass productivity and shape reproducibility. When a silicon substrate or a glass substrate is used, the photolithography method, the chemical etching method, and the like may be used.

<Solid Particles>

The term solid particle means a particle the shape of which is not specified and may be spherical, elliptic (rounded like a chicken egg), polygonal, rodlike, or the like. Still, spherical particles are preferable considering fillability and the reaction area. In embodiment 1, spherical solid particles are used. Spherical solid particles will be hereinafter referred to as beads. As a material for the solid particles (beads), a single polymer or copolymer of vinyl monomer such as styrene, vinyl chloride, acrylonitrile, vinyl acetate, acrylic ester, and methacrylic ester; a butadiene copolymer such as a styrene-butadiene copolymer and a methyl methacrylate-butadiene copolymer; and agarose can be exemplified.

As the reactants immobilized on the beads' surfaces, a protein such as antigen-antibody, a protein such as a fragment of the foregoing protein, and a molecule such as cDNA (complementary deoxyribonucleic acid), which can be a host molecule and specifically identifies a target, can be exemplified. As the method of immobilization, a well known method may be used such as the physical adsorption method, the chemical bonding method, and the covalent binding method. When the terms solid particles and beads are used, it is assumed that reactants are immobilized on the surfaces of the solid particles and beads, unless otherwise stated.

The size of the beads is preferably 0.1-10 μm.

<Method of Measurement>

A test solution (e.g., a solution containing an antigen) is injected from the injection aperture 10. The test solution enters the quantitative reaction zone 20 of the reaction path 17 through the introducing path 11, and is discharged out of the chip through the discharging path 15. Through this process, components of the test solution react with the reactants in the quantitative reaction zone 20.

Although the test solution is dispersed slightly beyond the quantitative reaction zone 20, the reaction path is assumed to have a minute diameter in the analytical microchip according to the present invention, and therefore, the amount of test solution dispersed beyond the quantitative reaction zone 20 is extremely small. In addition, since inventive microchips of the same size have the same degree of dispersion, there is substantially no degradation of detection reproducibility observed between the microchips.

After the test solution is allowed to flow in the reaction path, a washing solution made of a pH-adjusted buffer solution is usually allowed to flow in the reaction path in order to wash the test solution in the reaction path. As the method of washing, as in the course for the test solution, the washing solution, instead of the test solution, may be injected from the injection aperture 10 and discharged through the discharging path 15. In order to sufficiently wash the reaction path filled with solid particles, however, a large amount of washing solution needs to be allowed to flow. To this end, a preferred course is such that the washing solution is injected from the first washing aperture 16, which also serves as the particle injection aperture 16, and discharged through the second washing aperture 18. This is because the reaction path is usually formed to be larger than the diameter of the introducing path and the like, and the flow from the first washing aperture 16 to the second washing aperture 18 is orthogonal to the end surface 22 of the particle-filled area 19 (i.e., parallel to the axis), which enables it to allow a larger amount of washing solution to flow with a smaller injection pressure and thus provides better washing efficiency.

After washing out the test solution, a solution containing an identification substance attached with a label substance (e.g., a solution containing a second antibody attached with fluorochrome) is allowed to flow in order to cause the substance (antigen) in the test solution kept in the quantitative reaction zone to react with the identification substance (antigen-antibody reaction). Thus, composites are formed on the surfaces of the solid particles.

<Detection>

Then, a washing solution is allowed to flow in the above-described manner in order to wash inside of the reaction path, and the detection target substance is quantitated by, for example, detecting the amount of the fluorochrome in the quantitative reaction zone by a well known optical method.

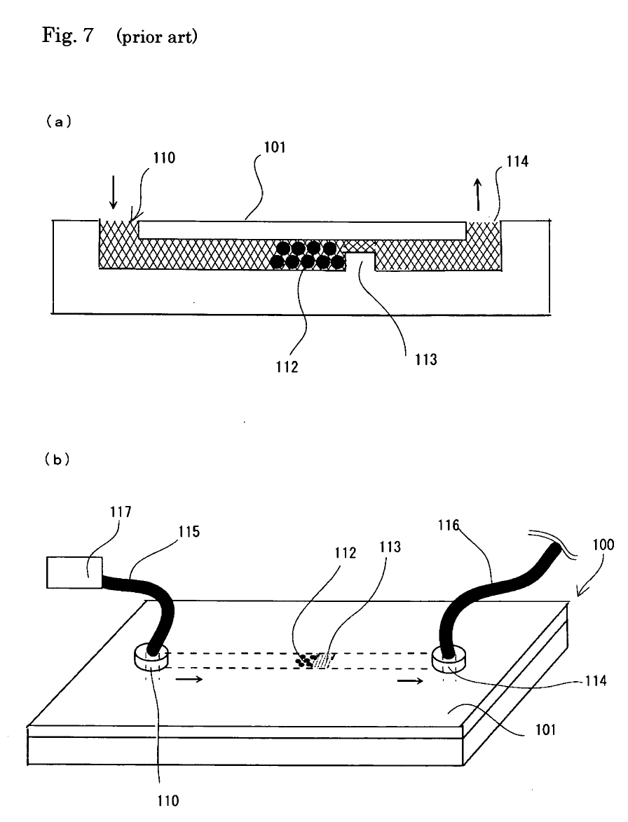

As described hereinbefore, according to embodiment 1, the amount of solid particles directly involved in reaction can be specified easily and accurately. When washing the reaction path, a larger amount of washing solution can be allowed to flow with a smaller pressure, resulting in a shortened time required for washing. Uniformizing the amount of solid particles means uniformizing the amount of reactants and the reaction area, and a shortened washing time enables more appropriate washing. Thus, according to embodiment 1, a highly accurate analysis with excellent reproducibility is made possible. On the contrary, in the microchip structure according to the prior art shown in FIG. 7, solid particles involved in reaction cannot be injected accurately, making it impossible to sufficiently enhance detection reproducibility.

### Embodiment 2

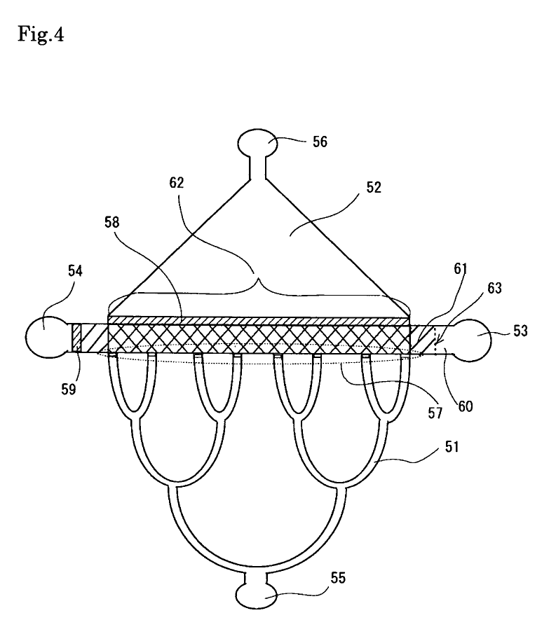

Embodiment 2 will be described with reference to FIG. 4, which is a plan view of a microchip according to embodiment 2, showing the main portions of the microchip. In embodiment 2, the structures of the reaction path, the test-solution introducing path, and the test-solution discharging path shown in FIG. 1 are respectively replaced with the structures shown in FIG. 4. The rest are as described in embodiment 1.

As shown in FIG. 4, in the structure of a microchip according to embodiment 2, a test-solution introducing paths 51 has a multi-stepwise furcation structure furcating into branches in a multi-stepwise manner (a three-stepwise furcation in FIG. 4) toward the lower stream. The test-solution introducing path 51, which has a multi-stepwise furcation structure, is located so as to be orthogonal to a reaction path 60. At one end (the right side in FIG. 4) of the reaction path 60, a first washing aperture is provided, and at the other end of the reaction path 60, a second washing aperture 54 is provided.

On the opposing side of the test-solution introducing path 51, which has a multi-stepwise furcation structure, a test-solution discharging path 52 is provided so that the reaction path 60 is between the test-solution introducing path 51 and the test-solution discharging path 52. The test-solution discharging path 52 has an inverted-triangle tapering structure such that a cross section parallel to the substrate surface tapers toward the lower stream.

As in embodiment 1, a group of first damming portions 57 are provided in the lowermost-stream-end flow paths of the test-solution introducing path 51. In the uppermost-stream-end (point of connection with the reaction path 60) of the test-solution discharging path 52, a second damming portion 58 is provided. Further, a third damming portion 59 is provided in front of the second washing aperture 54.

The distance between the end-side flow paths on the lowermost stream (tail end) of the test-solution introducing path 51 and the width of the bottom portion of the inverted triangle shape of the test-solution discharging path 52 are arranged to opposedly coincide. An area (particle-filled area 61) extending beyond the range of opposition between the test-solution introducing path 51 and test-solution discharging path 52 is filled with solid particles. In this structure, a test solution introduced from the lowermost-stream (tail end) flow paths of the test-solution introducing path 51 flows across the particle-filled area 61 into the bottom portion of the inverted triangle shape of the test-solution discharging path 52. Thus, the area of opposition between the end-side flow paths on the lowermost stream (tail end) of the test-solution introducing path 51 and the bottom portion of the inverted triangle shape of the test-solution discharging path 52 is the quantitative reaction zone.

In the structure of embodiment 2, since an unreacting test solution is introduced from a plurality of flow paths, the contact area between the unreacting test solution and the reactants is increased. This enhances reaction uniformity. Also, since the entrance of the discharging path has a large volume, a sufficient flow rate is secured with a smaller solution pressure. This enables it to shorten detection time while improving detection accuracy.

### Embodiment 3

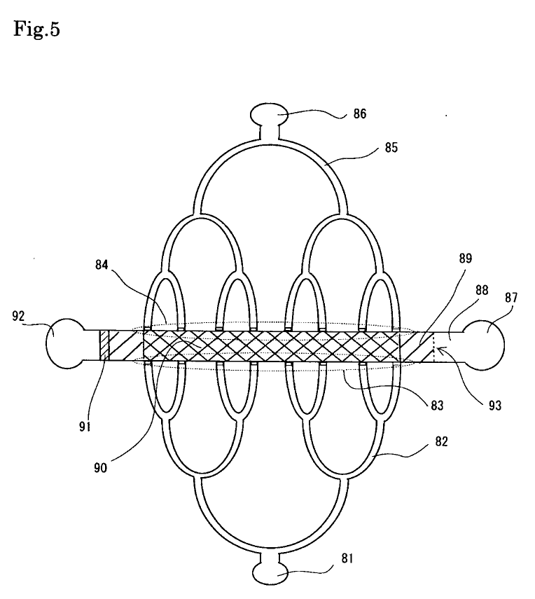

In embodiment 3, the test-solution discharging path having the inverted-triangle tapering structure in embodiment 2 is replaced with a discharging path having an inverse multi-stepwise furcation structure as shown in FIG. 5. The rest are as described in embodiment 1 or 2. Specifically, in embodiment 3, the test-solution discharging path 85 has an inverse multi-stepwise furcation structure furcating into a plurality of branches in an equal to or more than two steps (three steps in FIG. 5) from the lowermost stream side toward a reaction path 88. A group of second damming portions 84 are provided in the lowermost-stream portions (points of connection with the reaction path 88) of the discharging path having an inverse multi-stepwise furcation structure.

The uppermost-stream-side flow paths of the test-solution discharging path 85 having an inverse multi-stepwise furcation structure are arranged to oppose to the lowermost-stream-side flow paths of a test-solution introducing path 82 having a multi-stepwise furcation structure as described in embodiment 2. In this structure, a quantitative reaction zone 90 is the area defined by two planes, which are imaginary planes including line segments connecting the tail ends of the side-ends flow paths of the opposing introducing path 82 and discharging path 85, the imaginary planes defining a particle-filled area 89 to be the minimum area.

In FIG. 5, reference numeral 81 denotes a test-solution introducing aperture, 82 denotes a test-solution introducing path, 83 denotes a group of first damming portions, 84 denotes a group of second damming portions, 85 denotes a test-solution discharging path, 86 denotes a test-solution discharging aperture, 87 denotes a particle injection aperture (also serving as a first washing aperture), 88 denotes a reaction path, 91 denotes a third damming portion, 92 denotes a second washing aperture, 93 denotes the uppermost-stream-side end surface of the particle-filled area.

The number of steps of the multi-stepwise furcation structure and the inverse multi-stepwise furcation structure may be two or greater, and it is also possible to employ such a structure that the flow path diameter gradually diminishes as furcation proceeds. For example, applying this structure to the introducing path 82 uniformizes the flow pressure and flow rate. It is also possible to adapt the flow rate to gradually increase.

When a detected substance contained in a discharged solution discharged out of the reaction path is quantitated, the volume of the discharging path having an inverted triangle shape is quite large in the structure in FIG. 4, and thus the detected substance is dispersed in a solution already existing in the discharging path. This makes the detected substance less dense. While the structure in FIG. 4 is disadvantageous in this point, the structure in FIG. 5 is free of this problem, making it advantageous in quantitizing a detected substance contained in a discharged solution.

The present invention will be described in further detail using examples.

### EXAMPLE 1

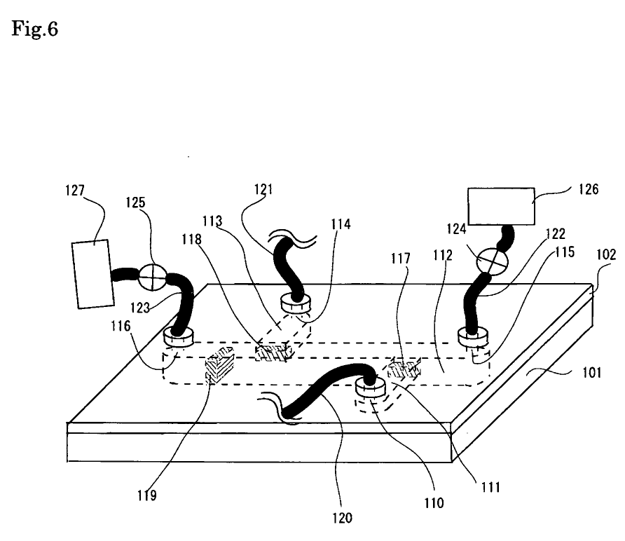

Example 1 is an example of a microchip analysis apparatus using the analytical microchip described in embodiment 1. FIG. 6 shows a schematic diagram of the apparatus. To avoid complication, only the main elements are accorded reference numeral.

<Chip Preparation>

As a main substrate 101 and a lid substrate 102, PMMA (polymethyl methacrylate), which is acrylic transparent resin, was used. In the main substrate 101, a test-solution introducing path 111, a test-solution discharging path 113, a reaction path 112, and damming portions 117, 118, and 119 were formed by heat-press molding using a metal mold. The groove width of the reaction path 112 was set to be 300 μm, the groove width of the test-solution discharging path 113 was set to be 100 μm, and the groove depth of all the foregoing was set to be 30 μm. Each of the damming portions was of a structure composed of a plurality of columns arranged at 5 μm intervals.

Next, the main substrate 101 and the lid substrate 102 were adhered to each other by heat compression. Then, in the lid substrate 102, apertures (apertures penetrating through the lid substrate) for a test-solution introducing aperture 110, a test-solution discharging aperture 114, a particle injection aperture (first washing aperture) 115, and a second washing aperture 116 were opened by the mechanical processing method. The diameter of the apertures was set to be 1 mm.

With the use of a cyanoacrylate adhesive, soft rubber tubes 120, 121, 122, and 123 having adhesive portions on the tips were attached respectively to the apertures 110, 114, 115, and 116. The tubes 122 and 123 were attached respectively with valves 124 and 125 for opening and closing the flow paths. The tubes 120, 121, 122, and 123 were attached with pumps as a solution supplying means, as shown by 126 and 127 for the tubes 122 and 123 (those for the tubes 120 and 121 are not shown). The valves and pumps may be provided as needed.

<Antibody-Immobilizing Beads>

As an antibody, anti-cryj I—IgG, which is an antibody of cryj I, which is a cedar pollen allergen, was used. This antibody was immobilized on beads surfaces by the covalent binding method. More specifically, with the use of carboxyl-modified polystyrene latex particles having an average particle diameter of 10 μm and N-hydroxysuccinimide/carbodiimide hydrochloride, the anti-cryj I—IgG antibody was immobilized on the beads' surfaces.

<Injection of Beads>

The valves 124 and 125 were opened to form the flow path: tube 122→particle injection aperture (first washing aperuture) 115→reaction path 112→second washing aperture 116→tube 123. Through the tube 122, a suspension having beads suspended in a PBS (Phosphate Buffered Saline) solution containing 0.1% BSA (Bovine Serum Albumin) was allowed to flow continuously in the flow path. The injection of beads was discontinued slightly before filling up the reaction path 112. After the injection, instead of the suspension, a washing solution made of a PBS solution containing 0.1% BSA was allowed to flow in order to wash inside of the reaction path. Then, the valves 124 and 125 were turned into a closed state to form the flow path: tube 120→introducing aperture 110→introducing path 111→reaction path 112→discharging path 113→discharging aperture 114→tube 121. Through the tube 120, a washing solution was allowed to flow in the flow path in order to wash the introduction/reaction/discharge flow path.

<Reaction>

Through the tube 120, biotin-modified cryj I was allowed to flow at 1 μl/min for 10 minutes in the introduction/reaction/discharge flow path in order to cause an antigen-antibody reaction of the cryj I and the anti-cryj I—IgG antibody immobilized on the beads. Then, the valves 124 and 125 were opened to allow a washing solution to flow at 40 μl/min for 3 minutes through the tube 122, thereby washing inside of the reaction path. Next, the valves 124 and 125 were closed, and fluorescent labeling streptavidin was allowed to flow at 1 μl/min for 10 minutes in the introduction/reaction/discharge flow path through the tube 120 in order to cause a biotin-avidin reaction. Then, again, the valve 124 and 125 were opened to allow a washing solution to flow at 40 μl/min for 3 minutes through the tube 122. By an optical means, the fluorescent intensity of the quantitative reaction zone was measured.

<Results>

Seven analytical microchips prepared under the same conditions were subjected to seven times of measurement using the same test solution. The maximum variation of the fluorescent intensity among the chips was approximately 10% with respect to the average value. The term maximum variation is a value defined by the following formula 1.
Maximum variation (%)=100×|average value−measured value furthest from the average value|/average value . . . (Formula 1)

where the symbol “||” denotes an absolute value.

### EXAMPLE 2

A microchip of the structure shown in FIG. 4 was attached with tubes, valves, and pumps in the same manner as in example 1, and subjected to an experiment in the same manner as in example 1.

<Results>

As a result of seven times of measurement of seven chips in the same manner as in example 1, the maximum variation of the fluorescent intensity among the chips was approximately 7% with respect to the average value.

### EXAMPLE 3

A microchip of the structure shown in FIG. 5 was attached with tubes, valves, and pumps in the same manner as in example 1, and subjected to an experiment in the same manner as in example 1.

<Results>

As a result of seven times of measurement of seven chips in the same manner as in example 1, the maximum variation of the fluorescent intensity among the chips was approximately 5% with respect to the average value.

### COMPARATIVE EXAMPLE 1

An apparatus (FIG. 7(b)) using a chip of the conventional structure shown in FIG. 7(a), which was attached with tubes 115 and 116 and had a pump 117 attached to the tube 115, was subjected to a measurement experiment.

First, the same amount of beads (suspension) as in example 1 was injected from the introducing aperture 110. Next, after allowing biotin-modified cryj I to flow at 1 μl/min for 10 minutes from the pump 117 in order to cause an antigen-antibody reaction, a washing solution was allowed to flow at 40 μl/min for 3 minutes from the pump 117. Further, fluorescent labeling streptavidin was allowed to flow at 1 μl/min for 10 minutes from the pump 117 in order to cause a biotin-avidin reaction. Then, a washing solution was allowed to flow at 40 μl/min for 3 minutes. Then, the fluorescent intensity of the reaction path 111 was measured. This measurement was carried out seven times using seven identical chips.

<Results>

As a result of the seven times of measurement, it was observed that the maximum variation of the fluorescent intensity among the chips was approximately 20% with respect to the average value.

The results seen in examples 1-3 and comparative example 1 can be considered as follows. In examples 1-3, the chip structures maintain the amount of beads (the total amount of antibodies immobilized on beads) actually involved in reaction at a constant level. That is, in examples 1-3, injecting a slightly excessive amount of beads automatically results in a formation of a quantitative reaction zone filled with a constant amount of beads. Reaction occurs only in this quantitative reaction zone. This diminishes measurement deviation caused by variation of the injection amount. Contrarily, the structure of comparative example 1 does not involve formation of a quantitative reaction zone, where variation of bead injection directly leads to variation of the amount of antibodies involved in reaction. This makes it difficult to accurately control the amount of bead injection. Thus, variation of the bead amount among chips causes variation of measured values.

Variation in examples 1-3 diminished in the order: example 1>example 2>example 3. This is because the structures of examples 2 and 3 have more flow paths to introduce the test solution into the quantitative reaction zone, and have a large number of points where the test solution comes into contact with solid particles while having similar densities. This enables reaction to proceed uniformly.

What is claimed is:

1. An analytical microchip comprising:
a reaction path formed in the microchip, the reaction path having a particle-filled area filled with a group of solid particles having reactants immobilized on surfaces of the solid particles;
a test-solution introducing path for introducing a test solution into the reaction path from outside of the microchip;
a test-solution discharging path for discharging a test solution inside the reaction path to outside of the microchip; and
a particle injection aperture for injecting solid particles into the reaction path, the particle injection aperture being provided on one end side of the reaction path, wherein:
the test-solution discharging path has a direct communication with the particle-filled area in the reaction path; and
the test-solution introducing path has a direct communication with the reaction path on an upper stream side relative to the test-solution discharging path and within an upper-stream-side end surface of the particle-filled area.

2. The analytical microchip according to claim 1, wherein:
the analytical microchip is at least composed of a main substrate having a groove for the reaction path, a groove for the test-solution introducing path, and a groove for the test-solution discharging path; and a lid substrate having a thorough aperture for the particle injection aperture, the lid substrate being superposed over the main substrate; and
the test-solution introducing path and the test-solution discharging path extend in opposite directions from the reaction path.

3. The analytical microchip according to claim 1, wherein:
a first damming portion for preventing solid particles from entering the test-solution introducing path is provided at a point of connection of the test-solution introducing path and the reaction path; and
a second damming portion for preventing solid particles from entering the test-solution discharging path is provided at a point of connection of the test-solution discharging path and the reaction path.

4. The analytical microchip according to claim 3, further comprising:
a washing aperture for injecting a washing solution to wash a group of solid particles in the reaction path out of the chip through the particle injection aperture, the washing aperture being provided at a lower stream end of the reaction path; and
a third damming portion for damming solid particles, the third damming portion being provided on an upper stream side relative to the washing aperture and on a side of the washing aperture relative to the test-solution discharging path.

5. The analytical microchip according to claim 4, wherein:
the analytical microchip is at least composed of a main substrate having a groove for the reaction path, a groove for the test-solution introducing path, and a groove for the test-solution discharging path; and a lid substrate having a thorough aperture for the particle injection aperture, the lid substrate being superposed over the main substrate; and
the test-solution introducing path and the test-solution discharging path extend in opposite directions from the reaction path.

6. The analytical microchip according to claim 5, wherein:
the washing aperture is formed of a thorough aperture provided in the lid substrate; and
the particle injection aperture also serves as a solid-particle discharging aperture for discharging a group of solid particles out of the chip.

7. The analytical microchip according to claim 5, wherein the lid substrate further has:
a thorough aperture for injecting a test solution into the test-solution introducing path from outside of the chip, the thorough aperture being formed on a uppermost stream side of the test-solution introducing path; and
a thorough aperture for discharging a test solution out of the test-solution discharging path to outside the chip, the thorough aperture being formed on a lowermost stream side of the test-solution discharging path.

8. The analytical microchip according to claim 6, wherein the lid substrate further has:
a thorough aperture for injecting a test solution into the test-solution introducing path from outside of the chip, the thorough aperture being formed on an uppermost stream side of the test-solution introducing path; and
a thorough aperture for discharging a test solution out of the test-solution discharging path to outside the chip, the thorough aperture being formed on a lowermost stream side of the test-solution discharging path.

9. An analytical microchip comprising:
a reaction path formed in the microchip, the reaction path having a particle-filled area filled with a group of solid particles having reactants immobilized on surfaces of the solid particles;
a test-solution introducing path for introducing a test solution into the reaction path from outside of the microchip;
a test-solution discharging path for discharging a test solution inside the reaction path to outside of the microchip; and
a particle injection aperture for injecting solid particles into the reaction path, the particle injection aperture being provided on one end side of the reaction path, wherein:
the test-solution introducing path is composed of a plurality of introducing paths;
the test-solution discharging path is composed of at least one discharging path;
the plurality of introducing paths each have a direct communication with the reaction path with end surfaces defining the particle-filled area, a lowermost-stream-side inner surface of a lowermost-stream-side flow path of the plurality of introducing paths being located at an equal level or on an upper stream side relative to a lowermost-stream-side wall surface of a lowermost-stream-side discharging path of the at least one test-solution discharging path.

10. The analytical microchip according to claim 9, wherein the plurality of introducing paths have a multi-stepwise furcation structure having, on an uppermost stream side, a single flow path furcating into branches in a multi-stepwise manner toward a lower stream side.

11. The analytical microchip according to claim 10, wherein the test-solution discharging path has an inverse multi-stepwise furcation structure furcating into branches in a multi-stepwise manner from a lowermost stream side of the discharging path toward an upper stream side thereof down to portions of connection with the reaction path.

12. The analytical microchip according to claim 10, wherein:
the test-solution discharging path has a wide connection portion with the reaction path in a longitudinal direction of the reaction path, the wide connection portion tapering toward the lower stream side of the test-solution discharging path, whereby the test-solution discharging path is a single discharging path having a tapering shape; and
a lower-stream-side inner wall of the test-solution discharging path at the connection portion with the reaction path is located at an equal level or on a lower stream side relative to a lower-stream-side inner surface of a lowermost-stream-side flow path of the plurality of introducing paths.

13. The analytical microchip according to claim 9, wherein:
the analytical microchip is at least composed of a main substrate having a groove for the reaction path, a groove for the test-solution introducing path, and a groove for the test-solution discharging path; and a lid substrate having a thorough aperture for the particle injection aperture, the lid substrate being superposed over the main substrate; and
the test-solution introducing path and the test-solution discharging path extend in opposite directions from the reaction path.

14. The analytical microchip according to claim 13, wherein:
the washing aperture is formed of a thorough aperture provided in the lid substrate; and
the particle injection aperture also serves as a solid-particle discharging aperture for discharging a group of solid particles out of the chip.

15. The analytical microchip according to claim 14, wherein the lid substrate further has:
a thorough aperture for injecting a test solution into the test-solution introducing path from outside of the chip, the thorough aperture being formed on an uppermost stream side of the test-solution introducing path; and
a thorough aperture for discharging a test solution out of the test-solution discharging path to outside the chip, the thorough aperture being formed on a lowermost stream side of the test-solution discharging path.

16. The analytical microchip according to claim 9, wherein:
a first damming portion for preventing solid particles from entering the test-solution introducing path is provided at a point of connection of the test-solution introducing path and the reaction path; and
a second damming portion for preventing solid particles from entering the test-solution discharging path is provided at a point of connection of the test-solution discharging path and the reaction path.

17. The analytical microchip according to claim 16, further comprising:
a washing aperture for injecting a washing solution to wash a group of solid particles in the reaction path out of the chip through the particle injection aperture, the washing aperture being provided at a lower stream end of the reaction path; and
a third damming portion for damming solid particles, the third damming portion being provided on an upper stream side relative to the washing aperture and on a side of the washing aperture relative to the test-solution discharging path.
